(19) United States
(12) Patent Application Publication
(10) Pub. No.: US 2015/0181160 A1
(43) Pub. Date: Jun. 25, 2015

(54) CLOUD MONITORING SYSTEM

(71) Applicant: Amaryllo International, Inc., Zhubei City (TW)

(72) Inventors: Chao-Tung Yang, Zhubei City (TW); Yi-Hsin Tsai, Zhubei City (TW)

(73) Assignee: Amaryllo International, Inc., Zhubei City (TW)

(21) Appl. No.: 14/135,461

(22) Filed: Dec. 19, 2013

(51) Int. Cl. H04N 7/14; H04L 29/08

(52) U.S. Cl. CPC H04N 7/147; H04L 67/10

(57) ABSTRACT

A cloud monitoring system includes at least one webcam device, at least one monitoring controlling module, at least one operation executing device, and an authorizing module. The webcam device is provided for monitoring a scene of environment and sending the scene via a network. The monitoring controlling module is provided in an end-user networking device. The operation executing device and the authorizing module are connected with the network. By the authorizing module, an observation privilege of the webcam device of the monitoring controlling module is authorized to another specific monitoring controlling module to display the scene on a screen of the end-user networking device of the specific monitoring controlling module, and/or the authorizing module authorizes a controlling privilege of the operation executing device to the monitoring controlling module specifically to allow the operation executing device to execute an operation by operating a controlling element of the monitoring controlling module.

### FIELD OF THE INVENTION

The present invention relates to a monitoring system, and more particularly to a cloud monitoring system that monitors environment and executes an operation according to a corresponding privilege.

### BACKGROUND OF THE INVENTION

With the development of the technology, monitoring systems are commonly used in the modern life. By using the monitoring system, we can observe the scene being monitored. And it thus can improve the security of home environment by reducing the happening of various insecurity incidents, such as thefts and traffic accidents.

Conventional monitoring system generally includes a video camera and a monitoring screen. In general, the monitoring screen is usually allocated fixedly and needs a specialized person, such as a security guard, to watch the monitoring screen continuously. However, it costs a lot of human resource. In addition, the conventional monitoring system generally only can be used to observe the environment but can not be used to response to the observed conditions accordingly.

Moreover, it is not proper for many places to be observed and monitored by other people due to the privacy. Moreover, the installation of the monitoring device and the monitoring devices themselves are expensive, and the maintenance thereof is also inconvenient and expensive for most of people. Therefore, the monitoring system is not widely used.

### SUMMARY OF THE INVENTION

The present invention is for solving the disadvantages as above of the conventional monitoring system.

Accordingly, an aspect of the present invention is to provide a cloud monitoring system that monitors environment and executes an operation according to a corresponding privilege.

The cloud monitoring system comprises at least one webcam device, at least one monitoring controlling module, at least one operation executing device, and an authorizing module. The webcam device is provided for monitoring a scene of environment, the scene of the webcam device is sent via a network. The monitoring controlling module is provided in an end-user networking device. The operation executing device is connected with the network. The authorizing module is connected with the network. By the authorizing module, an observation privilege of the webcam device of the monitoring controlling module is authorized to another specific monitoring controlling module to display the scene on a screen of the end-user networking device of the specific monitoring controlling module, and/or the authorizing module authorizes a controlling privilege of the operation executing device to the monitoring controlling module specifically to allow the operation executing device to execute an operation by operating a controlling element of the monitoring controlling module.

According to another aspect of the present invention, the webcam device has a fixed IP address.

According to another aspect of the present invention, it further comprises a message notifying element connected with the network for sending a notification message to the end-user networking device via the network.

According to another aspect of the present invention, the operation executing device is a locking device or an unlocking device.

According to another aspect of the present invention, the authorizing module is provided in a network sever device.

According to another aspect of the present invention, it further comprises a scene sharing module for providing a scene sharing configuration that shares the scene of the environment to a plurality of the monitoring controlling modules according to an identification information of the monitoring controlling module.

According to another aspect of the present invention, it further comprises a join control module for providing a join control configuration that allows any one of a group of a plurality of the monitoring controlling modules to own a control privilege of the operation executing device according to an identification information of the monitoring controlling module.

According to another aspect of the present invention, it further comprises a community setting module for providing a community configuration for grouping a plurality of the monitoring controlling modules.

According to another aspect of the present invention, it further comprises a group setting module providing a group configuration for grouping a plurality of the webcam devices and the operation executing devices.

According to another aspect of the present invention, the monitoring controlling module includes an icon selection element corresponding to the webcam device or the operation executing device.

According to another aspect of the present invention, the monitoring controlling module executes a grouping operation to group a plurality of the icon selecting elements according to the location relation between a plurality of the webcam devices and the operation executing devices.

According to another aspect of the present invention, the icon selecting element is a webcam selecting icon, and the scene of the environment monitored by the webcam device is displayed on the screen by clicking the webcam selecting icon.

According to another aspect of the present invention, the icon selecting element is an operation selecting icon, and the operation of the operation executing devices is controlled by clicking the operation selecting icon.

According to another aspect of the present invention, the icon selecting element is a location selecting icon.

The cloud monitoring system of the present invention can be not only used for monitoring the scene of environment but also for controlling an operation executing device via a network, so a user can directly response in a remote manner according to the information of scene that is received. Since the present invention replaces the expensive conventional monitoring device with the end-user networking device, such as a mobile phone, the cost of the present invention is greatly reduced and the effort of maintenance is also getting much easier. And with the increasing use of the end-user networking devices such as a smart mobile phone, a PDA (Personal Digital Assistants), and a laptop computer, it will help to enhance an interest of public to install the cloud monitoring system of the present invention. The easy operation of the clouding monitoring system of the present invention, which is achieved by clicking icons on the end-user networking devices, is also advantageous. And it is convenient for the present invention to share the observation privilege of the webcam device and the controlling privilege of the operation executing device with other users, and will promote the security of the life as well.

### BRIEF DESCRIPTION OF THE DRAWINGS

The structure and the technical means adopted by the present invention to achieve the above and other objects can be best understood by referring to the following detailed description of embodiments and the accompanying drawings.

FIG. 1 is block diagram illustrating the cloud monitoring system according to an embodiment of the present invention.

FIG. 2 is a schematic diagram illustrating a cloud circle party according to an embodiment of the present invention.

FIG. 3 is a schematic diagram illustrating a building providing with the webcam devices and the operation executing devices according to an embodiment of the present invention.

FIG. 4 is a schematic diagram illustrating location selecting icons shown on one end-user networking device according to an embodiment of the present invention.

FIG. 5 is a schematic diagram illustrating webcam selecting icons and operation selecting icons shown on one end-user networking device according to an embodiment of the present invention.

FIG. 6 is a schematic diagram illustrating the cloud circle party after grouped according to an embodiment of the present invention.

FIG. 7 is a schematic diagram illustrating a sharing status of a webcam device according to an embodiment of the present invention.

FIG. 8 is a schematic diagram illustrating a sharing status of a operation executing device according to an embodiment of the present invention.

FIG. 9 is a schematic diagram illustrating icon selecting elements shown on another one end-user networking device according to an embodiment of the present invention.

FIG. 10 is a schematic diagram illustrating icon selecting elements shown on another one end-user networking device according to an embodiment of the present invention.

### DETAILED DESCRIPTION OF EMBODIMENTS

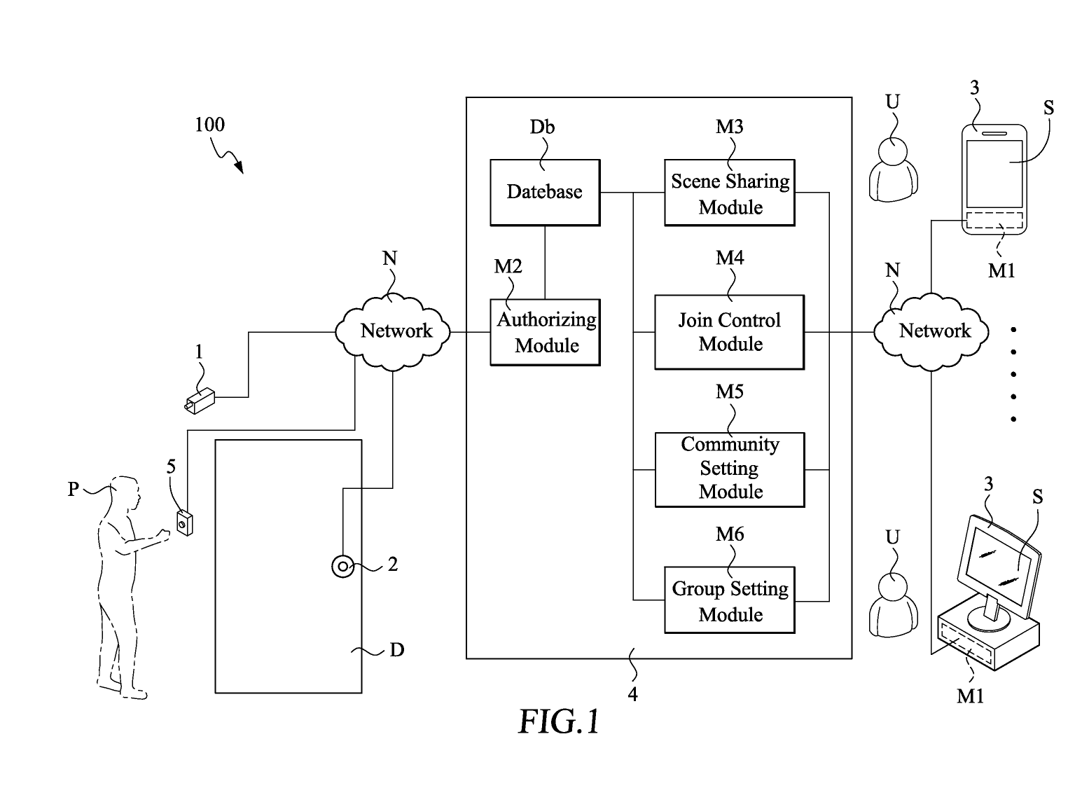

Refer to FIG. 1. The cloud monitoring system 100 includes at least one webcam device 1, at least one monitoring controlling module M1, at least one operation executing device 2, and an authorizing module M2.

The webcam device 1 is provided for monitoring a scene of environment and sending the scene of the environment via a network N. In this embodiment, the webcam device 1 is arranged nearby a door D of a house for monitoring the environment in front of the door D.

The monitoring controlling module M1 provided in an end-user networking device 3. The end-user networking device 3 can be a mobile device or a computer, but not limits to these. In this embodiment, the monitoring controlling module M1 can be an APP (application software) installed in the end-user networking device 3.

The operation executing device 2 is connected with the network N. In this embodiment, the operation executing device 2 is an unlocking device. In an embodiment, the operation executing device 2 also can be a locking device. In other words, the operation executing device 2 can be operated to open the door or further to lock the door. The operation executing device 2 can be communicated by any kinds of network protocols.

In this embodiment, the webcam device 1 and the operation executing device 2 can be configured to have their respective fixed IP (interne protocol) addresses. The monitoring controlling module M1 has an identification information that is used for identifying devices of the cloud monitoring system 100. The identification information is a registration information that is received, through the network N, by the registration of an user and is stored in a database Db of the network sever device 4. However, the present invention is not limited to this. The identification information of the monitoring controlling module M1 also can be an IP address of the end-user networking device 3 that is installed with the controlling module M1. The database Db of the network sever device 4 stores the IP address of all webcam devices 1, the IP address of all operation executing devices 2, and the identification information of all monitoring controlling modules M1.

In this embodiment, the authorizing module M2 is a database program installed in a network sever device 4. The authorizing module M2 is connected with the database Db and the network N. Based on the data in the database Db, the authorizing module M2 can authorize an observation privilege of the webcam device 1 to the monitoring controlling module M1 specifically to display the scene of the environment on a screen S of the end-user networking device 3 installed with the monitoring controlling module M1, for example, the scene showing a front view of the door D. Similarly, based on the data in the database Db, the authorizing module M2 can authorize a controlling privilege of the operation executing device 2 to the monitoring controlling module M1 specifically to allow the operation executing device 2 to execute an operation by operating a controlling element of the monitoring controlling module M1. However, the present invention is not limited to these. In other embodiment, the authorizing module M2 also can be an APP (Application software) program module installed in the end-user networking device 3, and thus a user U can change the authorization of the observation privilege and that of the controlling privilege by directly operating the authorizing module M2 on the end-user networking device 3.

In addition, in embodiments, the cloud monitoring system 100 further includes a message notifying element 5 connected with the network N. The message notifying element 5 is provided for sending a notification message to the end-user networking device 3 via the network N by an operator P.

In an embodiment of the present invention, for example, the message notifying element 5 is a doorbell which is nearby the door D and is communicated with the end-user networking device 3 by any kinds of network protocols. When an operator P presses the message notifying element 5, such as a doorbell, not only the doorbell rings, but also the end-user networking device 3 can receive the notification message from doorbell, so that the user U of the end-user networking device 3 can aware of the ring of the doorbell. At the same time, the webcam device 1 may be turned on and take a snapshot of the operator's P face while the doorbell is pressed. And the user U can further watch the operator's P face on the screen S and decide to open or to close the door D by operating the controlling element of the monitoring controlling module M1 on the end-user networking device 3. However, the present invention is not limited to this, the webcam device 1 and the operation executing device 2 also can be allocated in other place. For example, the webcam device 1 can be used for monitoring a kitchen, and the operation executing device 2 also can be a gas burner, an electric rice cooker, or an extractor fan that can be operated by the user U of the end-user networking device 3.

The present invention allows a plurality of users U to watch the scene sent from one of the webcam device 1 on their own different end-user networking devices 3. In an embodiment, the cloud monitoring system 100 further includes a scene sharing module M3 installed in the network sever device 4 (but not limited to that, in other embodiment, the scene sharing module M3 also can be an APP (Application software) program module installed in the end-user networking device 3). The scene sharing module M3 is connected with the database Db. The scene sharing module M3 can provide a scene sharing configuration that shares the scene of the environment to a plurality of the monitoring controlling modules M1 according to an identification information of the monitoring controlling module M1. And the configuration setting result of the scene sharing module M3 can be further stored in the database Db, so that the authorizing module M2 is able to authorize the observation privilege of the webcam device 1 to a plurality the monitoring controlling modules M1 according to the configuration setting result of the scene sharing module M3. The end-user networking devices 3, where the monitoring controlling module M1 is installed therein and is configured to be shared, is able display the scene that is sent from the same webcam device 1 on their screens S. In the manner, it can enhance the usability of the cloud monitoring system 100 by choosing more users U to watch the scene of environment. For example, the monitoring controlling modules M1 of all members of a family's end-user networking devices 3 are configured to have the observation privilege, so that all members of a family can watch the scene of their home together to improve the home security.

Moreover, the present invention is able to allow a plurality of users U to control the same operation executing device 2 by means of different end-user networking devices 3. In an embodiment, the cloud monitoring system 100 further includes a join control module M4 which is either installed in the network sever device 4 or in the end-user networking device 3. The join control module M4 is connected with the database Db. The join control module M4 can provide a join control configuration that allows any one of a group of a plurality of the monitoring controlling modules M1 to own a control privilege of the operation executing device 2 according to an identification information of the monitoring controlling module M1. And the configuration setting result of the join control module M4 is further stored in the database Db, so that the authorizing module M2 is able to authorize the controlling privilege of the operation executing device 2 to a plurality the monitoring controlling modules M1 according to the configuration setting result of the join control module M4. And the controlling element of the monitoring controlling module M1, which is set to be shared, can be used to control the operation executing device 2. In the manner, it can enhance the convenience of the cloud monitoring system 100 by choosing more monitoring controlling modules M1 for controlling the operation executing device 2. For example, the monitoring controlling modules M1 of all members of a family's end-user networking devices 3 are configured to have the controlling privilege, so that all members of the family can open or lock the door D of their house.

Furthermore, the present invention is able to group a plurality of the controlling modules M1. The cloud monitoring system 100 further includes a community setting module M5 either installed in the network sever device 4 or in the end-user networking device 3. The community setting module M5 is connected with the database Db. The community setting module M5 can provide a community configuration for grouping a plurality of the monitoring controlling modules M1. And the configuration setting result of the community setting module M5 is further stored in the database Db. In addition, by means of the community configuration, the motoring privilege and the controlling privilege can be easily shared to other controlling modules M1 belonging to the same community.

Also, the present invention is able to group a plurality of the webcam devices 1 and the operation executing devices 2. The cloud monitoring system 100 further includes a group setting module M6 either installed in the network sever device 4 or in the end-user networking device 3. The group setting module M6 is connected with the database Db. The group setting module M6 can provide a group configuration for grouping a plurality of the webcam devices 1 and the operation executing devices 2. And the configuration setting result of the group setting module M6 is further stored in the database Db.

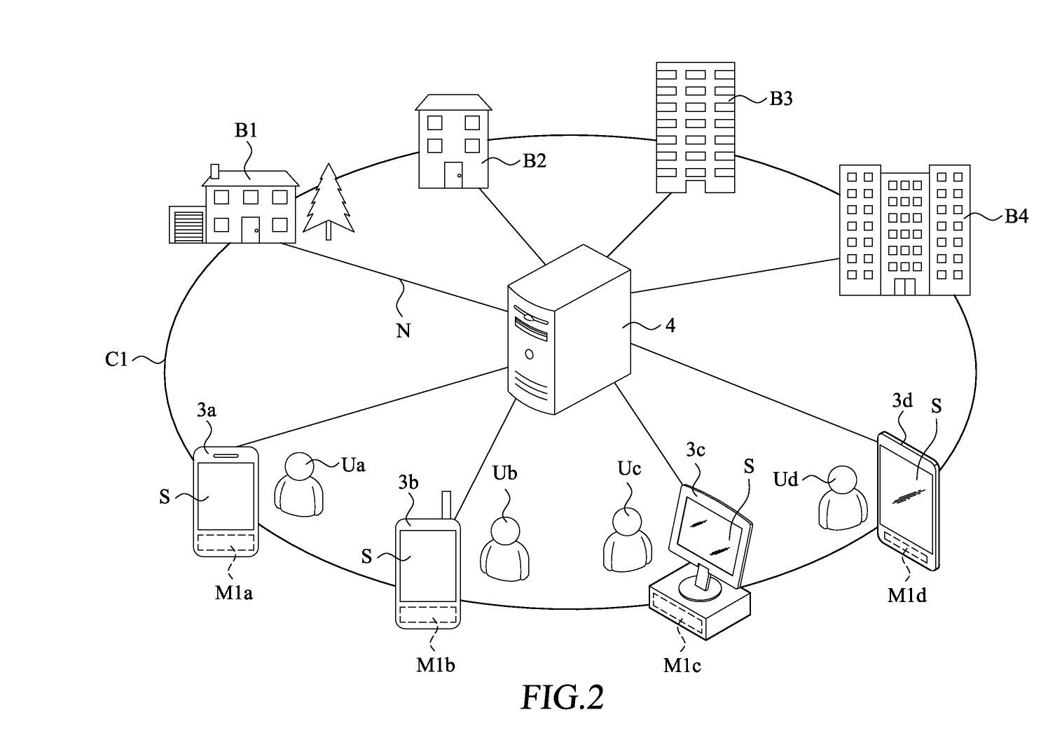

Also refer to FIG. 2 to FIG. 10, the application of the cloud monitoring system 100 of the present invention is described more specifically as follows:

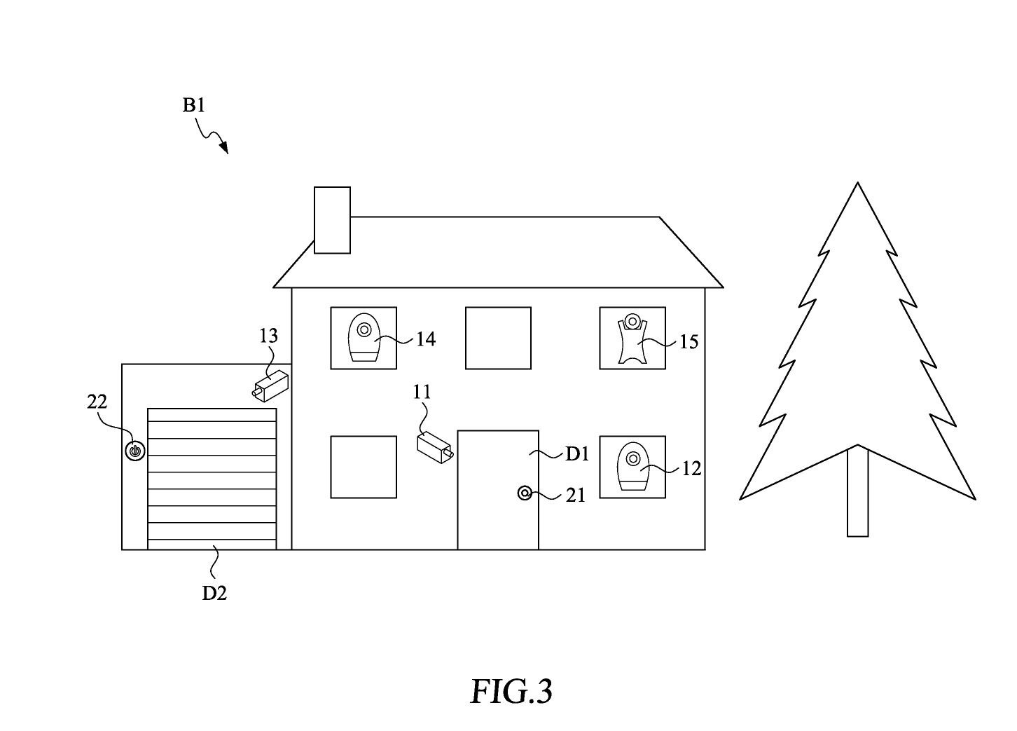

As shown in FIG. 2, FIG. 2 is a schematic diagram illustrating a cloud circle party according to an embodiment of the present invention. Buildings B1, B2, B3, and B4 are provided with various webcam devices 1 and the operation executing devices 2 therein. Taking the building B1 for example, the building B1 is provided with a webcam device 11 nearby the door D1, a webcam device 12 in the living room, a webcam device 13 in front of the garage, a webcam device 14 in the study room, a webcam device 15 in the kid's room, an operation executing device 21 on the door D1, and an operation executing device 22 of the door D2 of the garage, as show in FIG. 3. In the cloud circle party C1, the devices, including the webcam devices and the operation executing devices, provided at the Buildings B1, B2, B3, B4 are selectively communicated with the monitoring controlling modules M1a, M1b, M1c, M1d according to the authorization of the authorizing module M2.

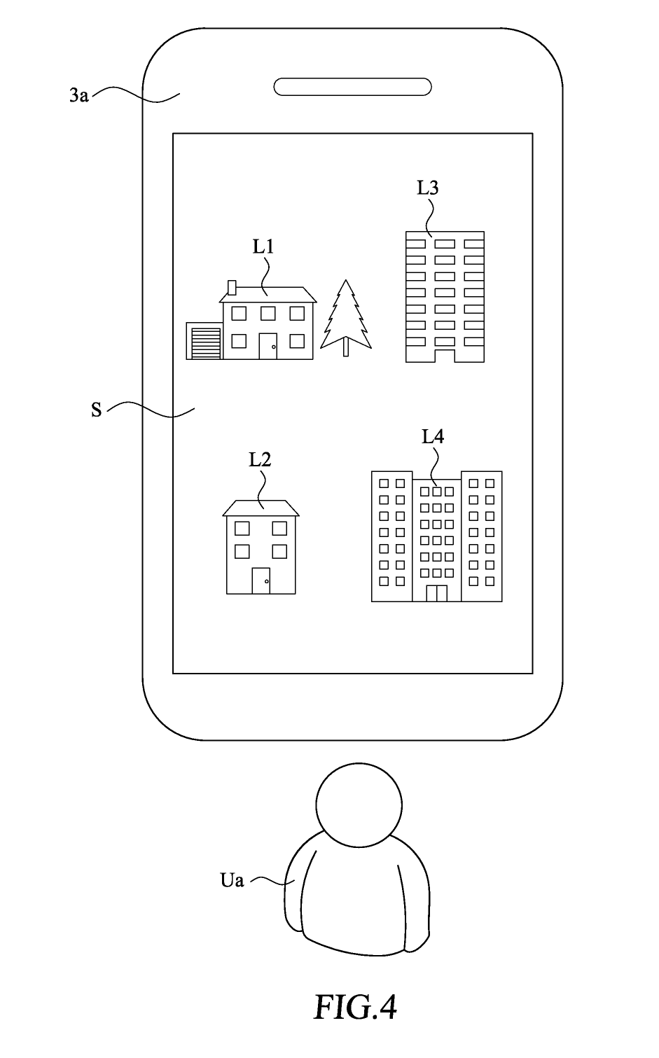

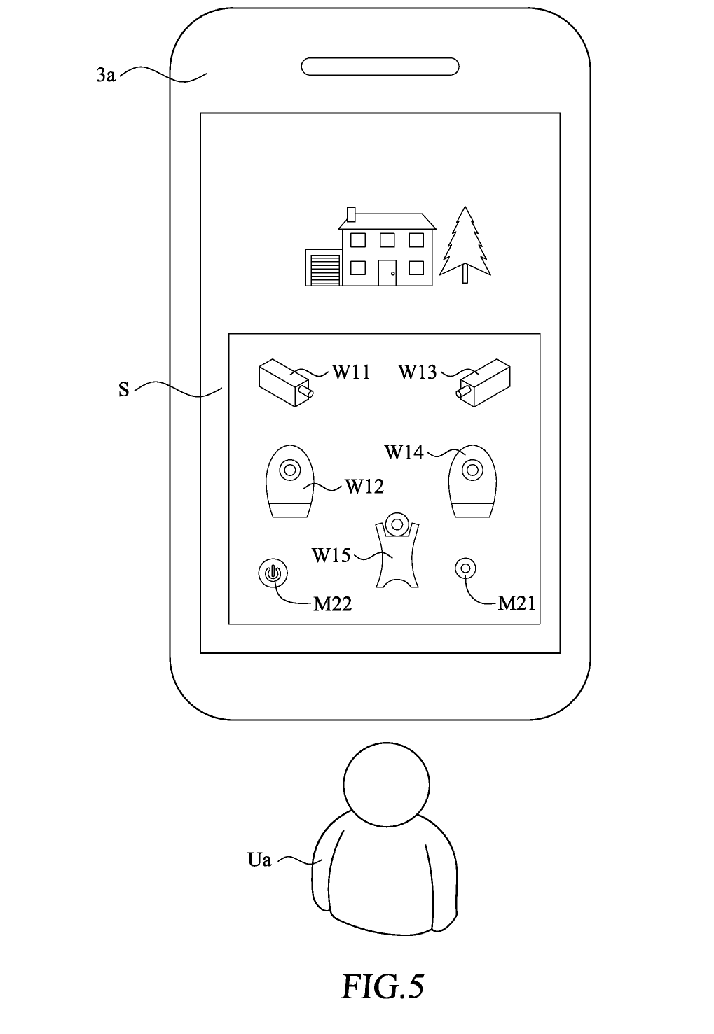

The monitoring controlling module includes an icon selecting element corresponding to the webcam device or the operation executing device. The icon selecting element may be a location selecting icon, a webcam selecting icon, or an operation selecting icon. As shown in FIG. 4, the monitoring controlling module M1a includes a plurality location selecting icons L1, L2, L3, L4 shown on the screen S of the end-user networking devices 3a. Since the monitoring controlling module M1a executes a grouping operation to group a plurality of webcam selecting icons and operation selecting icons according to the location relation between the webcam devices and the operation executing device. The webcam devices and the operation executing devices provided at the buildings B1, B2, B3, B4 can be shown on the screen S after a user Ua clicks the location selecting icons L1, L2, L3, L4, respectively. For example, after the user Ua clicks the location selecting icon L1, it can be found that there are webcam selecting icons W11, W12, W13, W14, W15 and operation selecting icons M21, M22 shown on the screen S, as shown in FIG. 5. Furthermore, by clicking the webcam selecting icons W11, W12, W13, W14, W15, the scene of the environment monitored by the webcam devices 11, 12, 13, 14, 15 are displayed on the screen S, respectively. And by clicking the operation selecting icons M21, M22, the operation executing devices 21, 22 can be controlled, respectively.

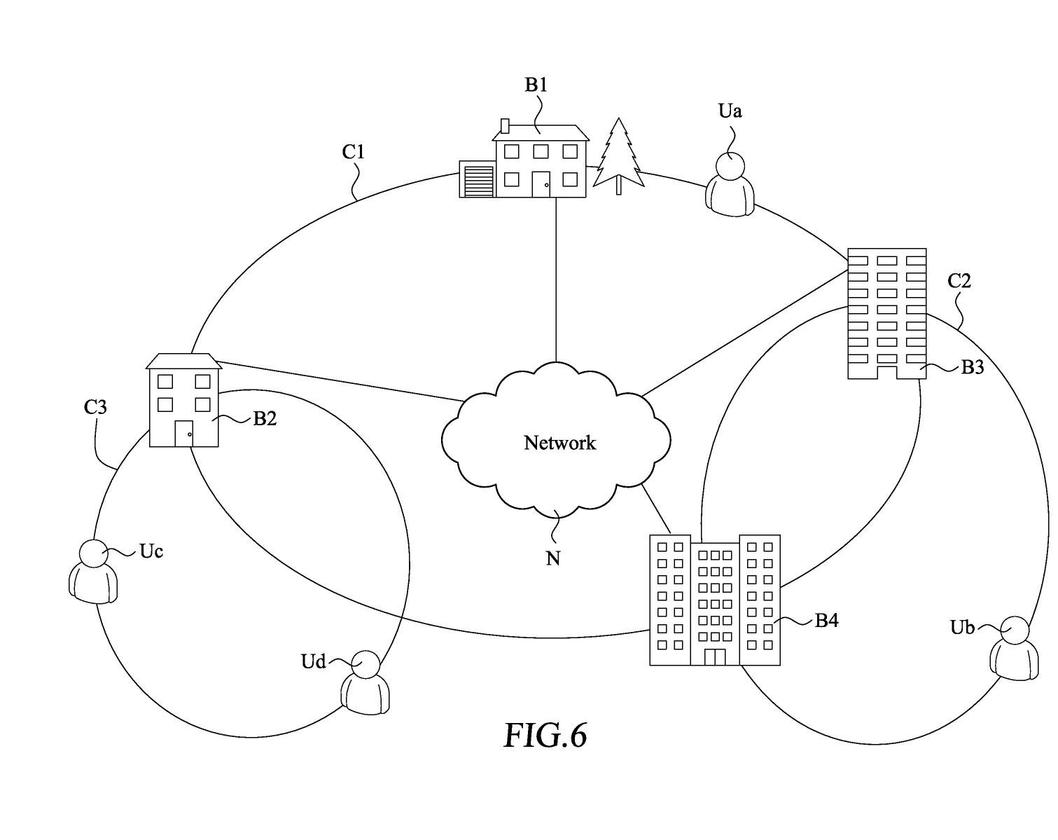

The authorization of the authorizing module M2 may be relative to the community configuration of the community setting module M5 and the group configuration of group setting module M6. As shown in the FIG. 6, according to the group configuration of group setting module M6, the webcam devices 1 and the operation executing devices 2 provided at the buildings B3, B4 are grouped into a cloud circle party C2, which is authorized to the users Ub. Also, according to the community configuration of community setting module M5, the monitoring controlling modules of the users Uc, Ud are grouped into a cloud circle party C3 having the privilege over the buildings B2.

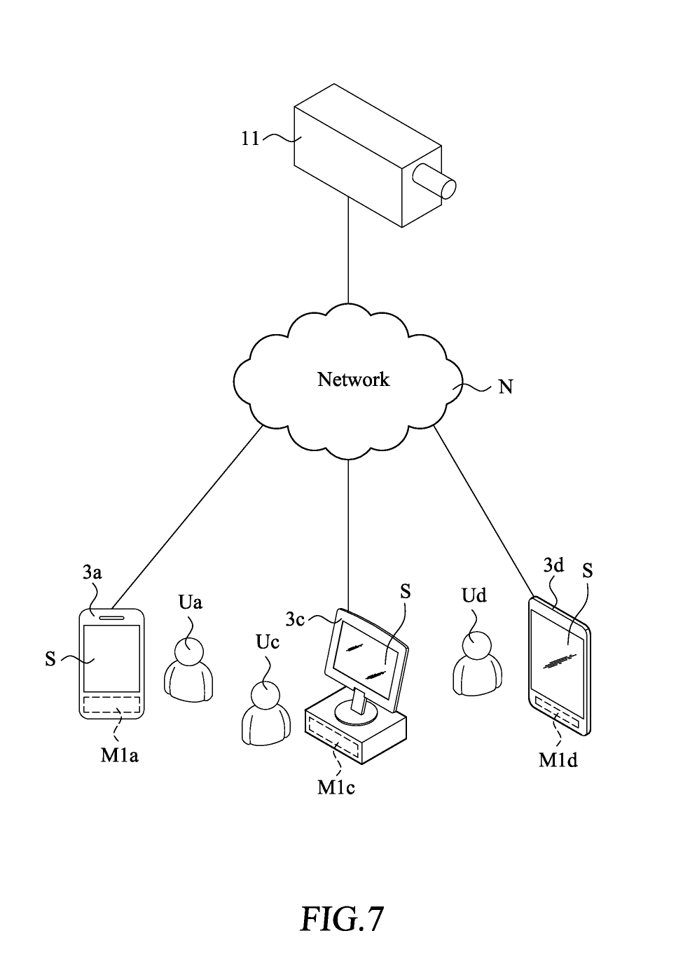

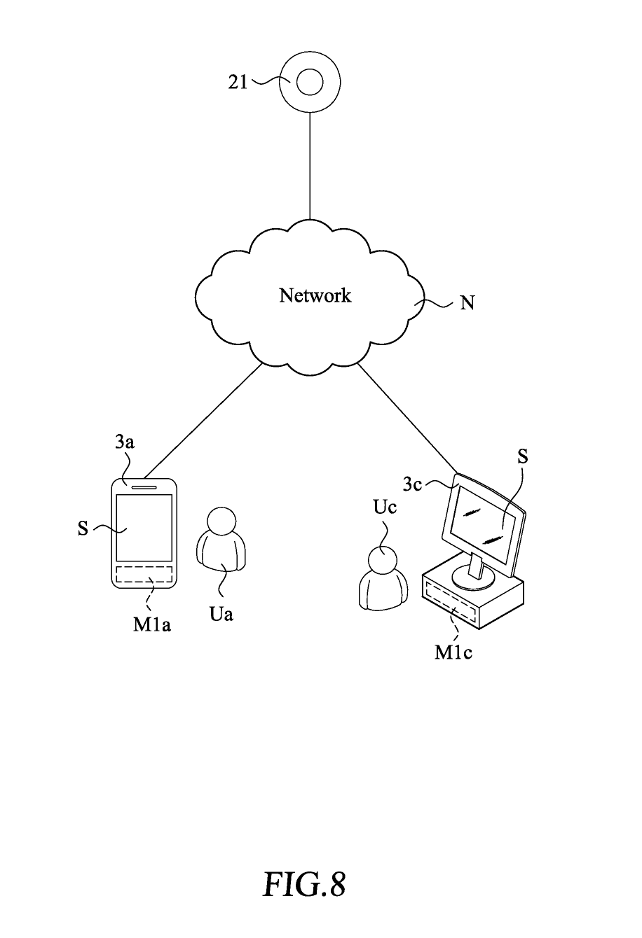

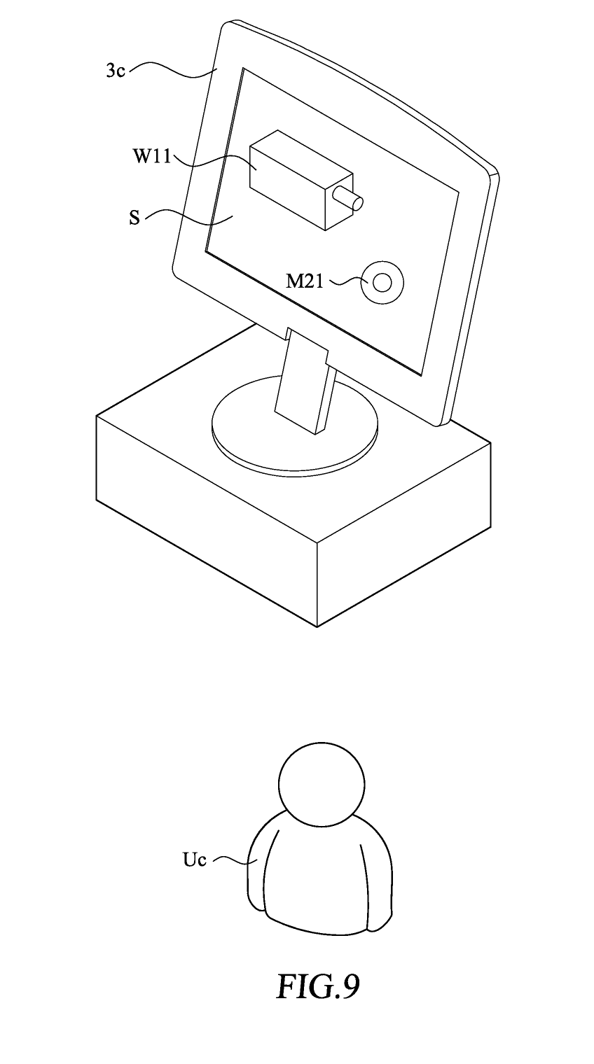

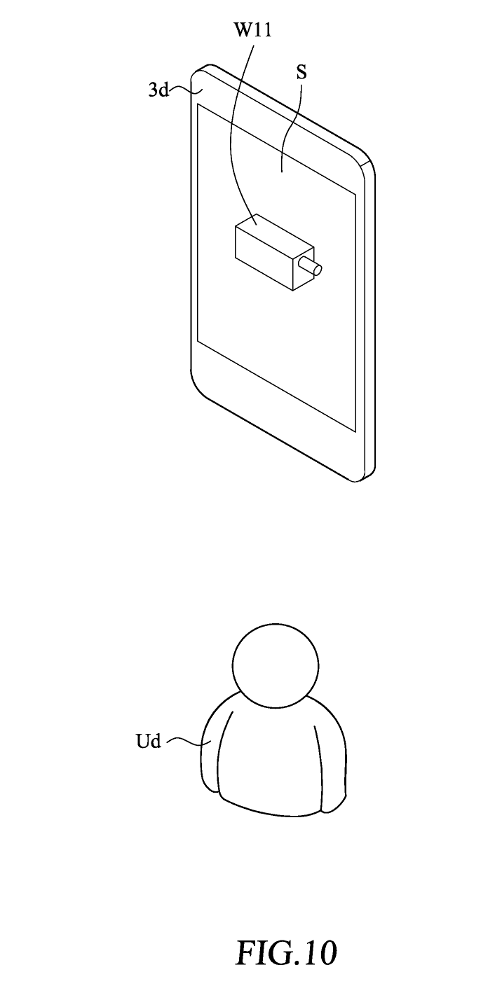

In addition, in spite that the users Uc, Ud do not have the full observation privilege and the full controlling privilege of the building B1. By means of the scene sharing module M3, the scene of the environment captured by the webcam device 11 in the building B1 also can be shared to the users Uc, Ud, as shown in FIG. 7. And by means of the join control module M4, the operation executing device 21 also can be controlled by the user Uc, as shown in FIG. 8. It thus if the user Uc clicks the location selecting icon L1, it can be found that there are webcam selecting icons W11 and operation selecting icons M21 shown on the screen S of the end-user networking devices 3c for further clicking, as shown in FIG. 9. And if the user Ud clicks the location selecting icon L1, it can be found that there is a webcam selecting icon W11 shown on the screen S of the end-user networking devices 3d for further clicking, as shown in FIG. 10. In this manner, it not only can enhance the safety of building B1 since the environment of the building B1 is monitored by much more people, but also can enhance the convenience since other people can help to manage the building B1.

The above description should be considered as only the discussion of embodiments of the present invention. However, a person skilled in the art may make various modifications to the present invention. However, those modifications still fall within the spirit and scope defined by the appended claims.

What is claimed is:

1. A cloud monitoring system, comprising:
at least one webcam device for monitoring a scene of environment, the scene of the webcam device being sent via a network;
at least one monitoring controlling module being provided in an end-user networking device;
at least one operation executing device being connected with the network; and
an authorizing module being connected with the network, the authorizing module authorizing an observation privilege of the webcam device to the monitoring controlling module to display the scene on a screen of the end-user networking device of the monitoring controlling module, and/or the authorizing module authorizing a controlling privilege of the operation executing device to the monitoring controlling module specifically to allow the operation executing device to execute an operation by operating a controlling element of the monitoring controlling module.

2. The cloud monitoring system as claimed in claim 1, wherein the webcam device has a fixed IP address.

3. The cloud monitoring system as claimed in claim 1, further comprising a message notifying element being connected with the network for sending a notification message to the end-user networking device via the network.

4. The cloud monitoring system as claimed in claim 1, wherein the operation executing device is a locking device or an unlocking device.

5. The cloud monitoring system as claimed in claim 1, wherein the authorizing module is provided in a network sever device.

6. The cloud monitoring system as claimed in claim 1, further comprising a scene sharing module for providing a scene sharing configuration that shares the scene of the environment to a plurality of the monitoring controlling modules according to an identification information of the monitoring controlling module.

7. The cloud monitoring system as claimed in claim 1, further comprising a join control module for providing a join control configuration that allows any one of a group of a plurality of the monitoring controlling modules to own a control privilege of the operation executing device according to an identification information of the monitoring controlling module.

8. The cloud monitoring system as claimed in claim 1, further comprising a community setting module for providing a community configuration for grouping a plurality of the monitoring controlling modules.

9. The cloud monitoring system as claimed in claim 1, further comprising a group setting module providing a group configuration for grouping a plurality of the webcam devices and the operation executing devices.

10. The cloud monitoring system as claimed in claim 1, wherein the monitoring controlling module includes an icon selection element corresponding to the webcam device or the operation executing device.

11. The cloud monitoring system as claimed in claim 10, wherein the monitoring controlling module executes a grouping operation to group a plurality of the icon selecting elements according to the location relation between a plurality of the webcam devices and the operation executing devices.

12. The cloud monitoring system as claimed in claim 10, wherein the icon selecting element is a webcam selecting icon, and the scene of the environment monitored by the webcam device is displayed on the screen by clicking the webcam selecting icon.

13. The cloud monitoring system as claimed in claim 10, wherein the icon selecting element is an operation selecting icon, and the operation of the operation executing devices is controlled by clicking the operation selecting icon.

14. The cloud monitoring system as claimed in claim 10, wherein the icon selecting element is a location selecting icon.
